(19) United States
(12) Patent Application Publication
(10) Pub. No.: US 2018/0022050 A1
(43) Pub. Date: Jan. 25, 2018

(54) Powder Press Having a Conical Lower Ram, Method for Operating a Powder Press, Pellet Produced by Way of a Powder Press, Lower Ram of a Powder Press, and Computer Program Product for Moving Lower Rams of a Press

(71) Applicant: GKN Sinter Metals Engineering GmbH, Radevormwald (DE)

(72) Inventors: Eberhard Ernst, Eichenzell (DE); Rainer Schmitt, Wachtberg (DE); Hasim Tekines, Wachtberg (DE); Christian Siegert, Ahrweiler (DE)

(21) Appl. No.: 15/547,708

(22) PCT Filed: Jan. 29, 2016
(86) PCT No.: PCT/EP2016/051932

§ 371 Date: Jul. 31, 2017

(30) Foreign Application Priority Data
Feb. 2, 2015 (DE) 10 2015 201 785.0

(51) Int. Cl. B30B 11/02; B22F 3/03

(52) U.S. Cl. CPC B30B 11/02; B22F 3/03; B22F 2003/033

(57) ABSTRACT

A powder press is proposed with a die construction which has a conical lower ram (UE) with lower rams which are nested inside one another, wherein each lower ram has a longitudinal extent, in particular a cylindrical longitudinal extent, which is guided by way of a template (M), wherein a conical widened portion adjoins preferably every longitudinal extent, wherein a respective cone angle of the lower ram preferably increases from the inside to the outside.

The present invention relates to a powder press having conical lower punches, and to a production method and a compact produced with the proposed powder press.

A press structure is a decisive factor for determining what kinds of parts can be pressed for how long in what way. The applicant's DE 10 2014 003 726 discloses a press for producing dimensionally accurate green compacts, in which the tool structures used are optimally designed for equalizing elasticity between individual tool levels. To this end, a certain amount of technical effort is required in designing and also producing the tools.

The object of the present invention is to create a simplified press structure which can be produced by conventional methods and shortens the time required for a tool change in addition to time for setup.

This object is achieved by a powder press having the features of claim 1, by a method having the features of claim 11, and by a compact having the features of claim 13. Advantageous developments and configurations can be gathered from the respective dependent claims, wherein one or more features from the description and also from the figures can be combined to form further configurations. The wording of the independent claims should furthermore be understood as being a first attempt to reproduce the subject matter of the invention. Therefore, one or more features of the independent claims can be supplemented by one or more features, exchanged therefor or even deleted in order to comprehend the subject matter of the invention better.

A powder press having a tool structure is proposed, which has lower punches nested in one another, wherein each lower punch has a longitudinal extent, in particular a cylindrical longitudinal extent, which is guided through a die, wherein preferably each longitudinal extent is adjoined by a conical enlargement. Provision is made for example for a respective cone angle of the lower punches to increase from the inside out, while the respective longitudinal extent of the lower punches decreases from the inside out.

In one development, a punch holder directly adjoins the conical enlargement.

It is preferred for the conical enlargement of the respective lower punch to increase to such an extent that an associated punch holder terminates flush with the lower punch laterally on the outside.

One configuration provides for example for the conical enlargement of the lower punch to transition into a cylindrical portion, wherein the cylindrical portion has fastening means for a punch holder.

It is furthermore preferred for a punch holder to be connected directly to a lower punch by means of a bayonet fastener.

According to a preferred configuration, a connection between the punch holder and lower punch takes place without a pressure plate and clamping plate.

This likewise allows a simplified tool structure while at the same time dispensing with conventional ancillary equipment, in particular pressure plates, with the aim of:
force flow optimization implementable by a geometrically simple, funnel-shaped tool design, particularly in the case of rotationally symmetrical tools;
reduced effort in construction by dispensing with design optimization;
dispensing with additive manufacturing methods, since the simple tool elements can generally be produced on standard machine tools by machining methods;
shortening the inner tool elements, also with acceptance of the lengthening of the outer tool elements;
dispensing with complete elasticity equalization: equalization is generally still carried out by position control by the machine.

The tool structures can consist, both in one piece and also in a multipart manner by connecting technology, of optionally a head piece, connecting element and foot piece.

In particular, as far as uniform pressure application and especially relief of pressure across a width of the compact is concerned, it is advantageous for the lower punches to be constructed in a rotationally symmetrical manner.

According to a further concept of the invention, which can be claimed independently of and also in dependence on the above subject matter, a powder press is provided in which an upper punch has a longitudinal extent, in particular a cylindrical longitudinal extent, which extends into the die, wherein an expansion adjoins the longitudinal extent. Preferably, a plurality of upper punches that are nested in one another are constructed in the same way as the lower punches described above and in the following text.

It is furthermore preferred for the upper punch and/or the lower punch to be produced in one piece. It is also possible for the upper punch and/or the lower punch to be produced in a multipart manner.

According to a further concept of the invention, which can be pursued independently of and also in dependence on the above proposal of a powder press, a method for operating a powder press with lower punches as described above and in the following text, wherein equalization takes place via position control while the lower punches are being moved.

Preferably, a compact made of metal powder is created by the method and the powder press.

Also proposed is a compact produced with a powder press as described above and in the following text, wherein a density along a cross section of the compact is constant.

Also proposed is a lower punch of a powder press, wherein the lower punch has been produced by means of a machining method, by means of a primary forming method, pressing, cold forming and/or casting.

Also proposed is a computer program product for moving lower punches of a press, wherein computer program code means are stored in order to be run in a controller, said computer program code means allowing the lower punches to be moved under position control.

Further advantageous features and configurations can be gathered from the following figures. One or more features from one or more figures and also from the description above can, in this case, be combined to form further configurations. In particular, the figures serve to explain the invention and are not intended to limit the latter. In the figures:

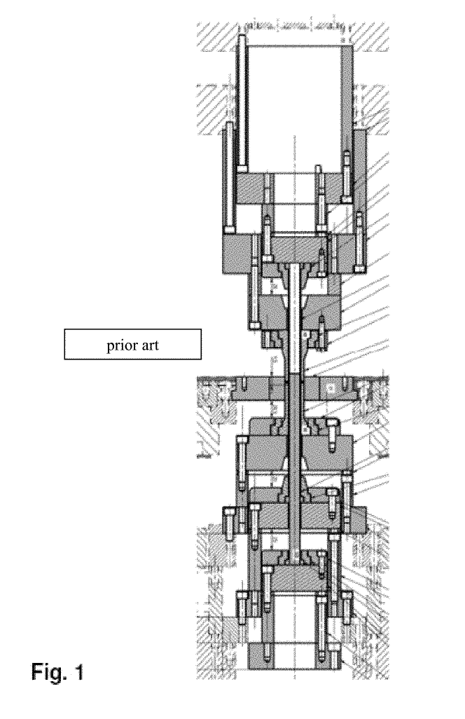

FIG. 1: shows a powder press from the prior art,

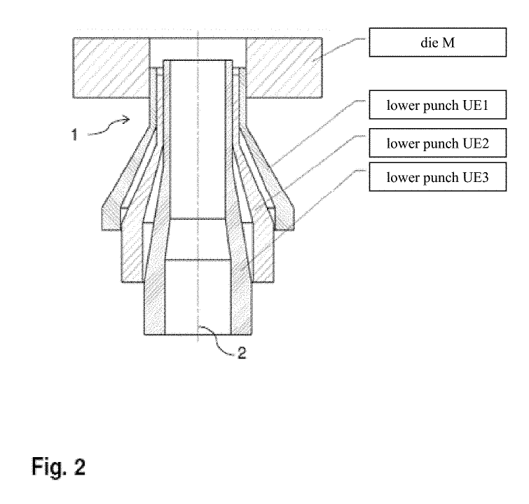

FIG. 2: shows an exemplary, schematic tool structure with conical lower punches,

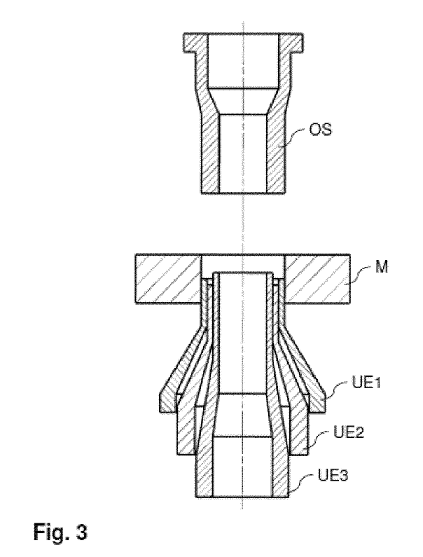

FIG. 3: shows a development of the illustration in FIG. 2 with a correspondingly adapted upper punch, and

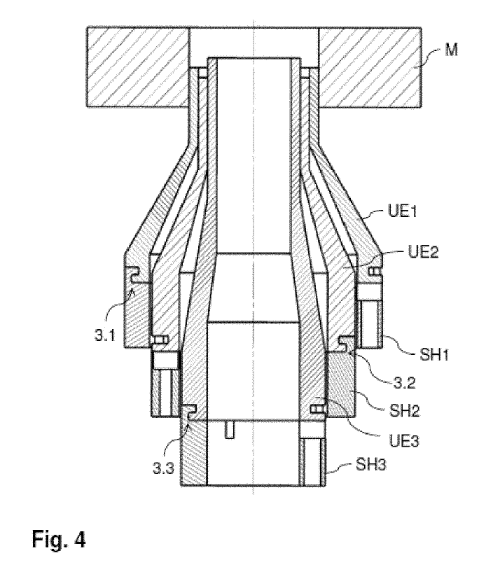

FIG. 4: shows a schematic view of the tool structure with conical lower punches and an attached punch holder.

FIG. 1 shows a powder press as is known from the prior art. Said press has a tool with a die, upper and lower punches and mandrels. As ancillary equipment, use is made of clamping plates, pressure plates and punch holders. The structure of the punches shows, for the one part, the necessary size that has to be provided for such a powder press. For the other part, the setup requires a certain effort, since, for this purpose, the clamping plates and pressure plates also have to be installed.

FIG. 2 shows an exemplary, schematic tool structure with a conical substructure. Provided in this embodiment, in addition to the die M, are three lower punches UE1, UE2, UE3. The lower punches have an upper region, the punch head 1, which is preferably cylindrical and extends into the die. Each lower punch then has a conical expansion, which is adjoined in each case by a cylindrical portion, here. The respective cone angle, i.e. the angle which is enclosed by the angle of the cone shape to the vertically drawn axis 2, preferably becomes smaller from the outside in, or in other words: a respective cone angle of the lower punches increases from the inside out. By contrast, the respective upper region becomes smaller from the inside out.

FIG. 3 shows a proposed tool structure for conical lower punches, in this case consisting of a die M, three lower punches UE1, UE2, UE3 and an upper punch OS. While the three lower punches are constructed similarly to those in FIG. 2, the upper punch OS can have an inverted, but comparable geometry to the lower punches.

FIG. 4 shows a tool structure for conical lower punches, having a die and three lower punches, which are connected to the punch holders SH1, SH2, SH3 by a fastening means, in this case in the form of a bayonet fastener 3.1, 3.2, 3.3.

1. A powder press comprising a tool structure which has a conical substructure with lower punches nested in one another, wherein each lower punch has a longitudinal extent, which is a cylindrical longitudinal extent, which is guided through a die, wherein each longitudinal extent is adjoined by a conical enlargement, wherein a respective cone angle of the lower punches increases from the inside out.

2. The powder press as claimed in claim 1, wherein the respective longitudinal extent of the lower punches decreases from the inside out.

3. The powder press as claimed in claim 1, wherein a punch holder directly adjoins the conical enlargement.

4. The powder press as claimed in claim 1, wherein the conical enlargement of the respective lower punch increases to such an extent that an associated punch holder terminates flush with the lower punch laterally on the outside.

5. The powder press as claimed in claim 1, wherein the conical enlargement of the lower punch transitions into a cylindrical portion, wherein the cylindrical portion has fastener for a punch holder.

6. The powder press as claimed in claim 1, wherein a punch holder is connected directly to a lower punch by a bayonet fastener.

7. The powder press as claimed in claim 1, wherein a connection between a punch holder and lower punch takes place without a pressure plate and a clamping plate.

8. The powder press as claimed in claim 1, wherein the lower punches are constructed in a rotationally symmetrical manner.

9. The powder press as claimed in claim 1, wherein an upper punch has a longitudinal extent which extends into the die, wherein an expansion adjoins the longitudinal extent.

10. The powder press as claimed in claim 1, wherein the upper punch and/or the lower punch are produced in one piece.

11. The powder press as claimed in claim 1, wherein the upper punch and/or the lower punch are produced in a multipart manner.

12. A method for operating a powder press having lower punches as claimed in claim 1, wherein equalization takes place via position control while the lower punches are being moved.

13. The method as claimed in claim 12, wherein a compact made of metal powder is created.

14. A compact produced with a powder press as claimed in claim 1, wherein a density along a cross section of the compact is constant.

15. A lower punch of a powder press as claimed in claim 1, wherein the lower punch has been produced by a machining method, by a primary forming method, pressing, cold forming and/or casting.

16. A computer program product for moving lower punches of a press as claimed in claim 1, wherein computer program code is stored in order to be run in a controller, said computer program code allowing the lower punches to be moved under position control.
